(19) United States
(12) Patent Application Publication
(10) Pub. No.: US 2008/0299373 A1
(43) Pub. Date: Dec. 4, 2008

(54) Method for Manufacturing a Composite Part with a Multicolored Surface, and a Composite Part Manufactured in this Manner

(76) Inventor: Luis Gonzalez, Tlaxcala (MX)

Correspondence Address: FAY KAPLUN & MARCIN, LLP, 150 BROADWAY, SUITE 702, NEW YORK, NY, 10038, US

(21) Appl. No.: 11/995,838

(22) PCT Filed: Jul. 17, 2006
(86) PCT No.: PCT/EP2006/007120

§ 371 Date: Jun. 4, 2008

(30) Foreign Application Priority Data
Jul. 18, 2005 (DE) 10 2005 034 257.4

(51) Int. Cl. B32B 33/00; B29C 44/14

(52) U.S. Cl. 428/220; 264/46.6

(57) ABSTRACT

A method of producing a composite part having a multicoloured surface and to a composite part having a multicoloured surface. The method contains the steps: (a) producing a multicoloured plastic film which has a groove in the area of the coloured regions adjacent to one another, (b) positioning the plastic film in a cavity of a tool, (c) partly drawing in the film regions lying along the groove into the interior of the cavity of the tool with the film regions drawn into the interior of the cavity simultaneously or subsequently being brought together for closing a recess, produced by the partial drawing-in of the film, between the film and the surface of the tool, (d) back foaming and/or back moulding the film. The method allows composite parts to be produced with a neater parting line between the individual coloured regions.

The invention relates to a method for manufacturing a composite part with a multicoloured surface, as well as to a composite part with a multicoloured surface.

Composite parts, in particular composite parts with multicoloured surfaces, are known. Such composite parts are applied for example in the automobile industry, as interior trim parts.

Moreover, it is known to manufacture such composite parts in a two-layered manner from a carrier and a multicoloured film.

Known methods for manufacturing a multicoloured film are the slush-moulding method and the moulding method.

It is known to manufacture a multicoloured film with the slush method by way of separating certain regions of the tool surface by way of seals, and manufacturing the different colour zones in the respective region,

Furthermore, it is known to manufacture a multicoloured film with the slush method by way of covering a region with a mask, removing this after the manufacture of a colour layer, and subsequently depositing a further colour layer, which covers the tool surface released by the mask.

Multicoloured films may be manufactured by way of the moulding method by way of covering the moulding tool in regions with paints of a different colour, analogously to mask technology of the slush method, and thereafter moulding a plastic mask, for example polyurethane, into the tool.

In order to manufacture the desired composite part, it is known to apply such films into a foaming tool or injection moulding tool and to back-foam or back-inject (back-mould or back-injection-mould) or back-inject-stamp them.

The problem with the manufacture of such composite parts is the manufactured of multicoloured films.

The disadvantage with the known method is the fact that the separation of the individual colour regions may often only be achieved to an inadequate degree. This is due to the insufficient or faulty sealing systems on the one hand, and to the flow behaviour of the plastic masses on the other hand.

The individual colours are often mingled in the border region of the two colour regions of the film. In principle, the film could be used for manufacturing a composite part, but a surface with such an undefined colour separation is usually not desirable.

It is then the object of the present invention, to provide a method which permits the manufacture of composite parts with a multicoloured surface with a clear separation of the individual colour regions whilst using a multicoloured film, which itself may have an indistinct separation of the individual colour regions. A further object of the present invention is to provide a composite part with a multicoloured surface which has a distinct separation line between the individual colour regions.

The invention achieves these objects by a method and a composite part according to the independent claims.

The invention provides a method for manufacturing a composite part with a multicoloured surface, containing the steps:
(a) manufacturing a multicoloured plastic film, which comprises a groove in the region of the colour regions bordering one another,
(b) positioning the plastic film in a cavity of a foaming tool,
(c) partly pulling the film region lying along the groove into the inside of the cavity of the foaming tool, with a simultaneous or subsequent leading-together of the film regions pulled into the inside of the cavity, for the closure of a recess between the film and the surface of the foaming tool, said recess being produced by the partial pulling-in of the film,
(d) back-foaming and/or back-injecting the film.

By way of the inventive pulling of the film along the separation line of the different colour regions, into the cavity of the tool, the region at which the different colour regions border one another, is removed from the viewed surface of the film. The gaps which arise due to the pulling-in of these film regions are closed by way of leading together the film regions which border one another. The film which is prepared in this manner is then back-foamed and/or back-injected. The border region of the colour regions bordering one another is thus located within the composite part which is manufactured in this manner. An undefined colour separation in this border region may therefore be completely hidden.

The region of the film which must be pulled into the cavity is characterised by the position of the groove. The dimensions of the groove are to be selected such that the indistinct border region between the individual colour regions lies completely within the groove.

The groove is advantageously formed as a web on the rear side of the film. This would result for example automatically with the selection of a uniform film wall thickness.

Such a web or bead simplifies the application of forces for pulling in the film regions lying along the groove, and in particular the leading-together of the film regions pulled into the inside of the cavity, for the closure of a recess produced by the partial pulling-in of the film.

The pulling-in and leading-together of the film is mechanically possible, but in particular may also be carried out by hand.

After preparation of the film, the film is back-injected and/or back-foamed. Back-injection-stamping of the film is likewise possible. The prepared film may basically be further processed in any way and manner.

Advantageous further formations of the invention are described in the dependent claims.

One advantageous further formation of the method envisages a vacuum being applied between the surface of the cavity of the foaming tool and the film, for holding the film.

The film is held in position by the vacuum. In particular, the film is not dislocated when the film regions lying along the groove are pulled into the cavity of the tool and led together. This however assumes that the film is stretchable to a certain extent. If the film were to be too stiff, then such a shape change would no longer be visible. In particular, it is advantageous to process the film in a warmed condition, for example at a temperature of above 60° C., in order to permit the necessary extension.

A further advantageous further formation of the invention envisages the tool comprising a web on the surface of its cavity, and the plastic film being positioned such that the web engages into the opening of the groove.

On the one hand, such a web permits a better positioning of the plastic film on positioning the plastic film in the cavity of the tool. The dimensions of the web are in particular smaller than that of the groove, in order to permit this positioning.

A further advantageous further formation of the method envisages the film being pulled into the inside of the cavity of the tool along the web.

According to the invention, the course of the separating line between the individual colour regions is defined by the web on the surface of the cavity. The course of the separating line is fixed in an unambiguous manner by way of this.

However, a gap remains on the viewed surface of the plastic film by way of the use of the web. The size and shape of the gap are determined essentially by the geometry of the web. Thus the optical effect of the separating region of the individual colour regions may be fashioned by the design of the web.

The web for example may have a rectangular shape. The gap of the plastic film then likewise has a rectangular shape.

In order to create a gap which is not optically conspicuous, a web in the shape of a pointed triangle is suitable. The height of the triangle is preferably very small, only a few millimetres. The triangular shape permits the film regions to be led together almost directly on the tip of the triangle. Also, an exactly predefined course of the separation line of the individual colour regions is made possible on account of the tip of the triangular web projecting out of the surface of the cavity.

One further advantageous formation of the invention envisages the groove of the film having a width in the region of 2.5 mm to 25 mm, preferably in a region from 3 mm to 7 mm, and a depth in the region of 2.5 mm to 15 mm, preferably in the region of 3 mm to 7 mm.

The width and the height of the groove are greatly dependent on the thickness of the plastic film, as well as on the geometry of the films. If two different colour regions border one another for example along an edge, then the groove may have other dimensions at this location than if the colour regions were to border one another in a common plane. Specified values are, and may thus only be guideline values.

In particular, these dimensions of the groove must be taken into consideration with a web or bead formed on the rear side of the plastic film. Mentioned values are in particular advantageous if the film regions bordering one another have a uniform wall thickness in this border region.

One further advantageous formation of the invention envisages the web having a width in the region of 1 mm to 5 mm, preferably in the region of 1 mm to 2 mm, and a height in the region of 1 mm to 7 mm, preferably in the region of 1 mm to 3 mm.

The size of the web on the surface of the cavity of the tool however is dependent on the size of the groove. According to the invention, the dimensions of the web are smaller than those of the groove, so that the web completely engages into the groove of the plastic film.

The specified values are likewise only to be seen a guidance values. If one wishes to apply the web in particular for optically fashioning the gap which is produced by the web in the surface of the plastic film, then the values may also lie outside the specified regions.

If the gap is to remain inconspicuous between the individual colour regions, then a triangular shape of the web on the surface of the cavity is useful, as well as a height and width which lies at the lower edge of the specified values.

One advantageous further formation of the invention envisages the film having a thickness in the region of 0.5 mm to 5 mm, preferably in the region of 1 mm to 2.5 mm.

On account of the method according to the invention, the film must have a certain extensibility. If the films are too thick, then the pulling-in and leading-together of the film regions lying on the groove becomes a problem.

One advantageous further formation of the invention envisages the film being manufactured in a moulding method or a slush method.

Basically however, the method according to the invention is independent of the manufacture of the multicoloured plastic film. What is essential are material characteristics as well as the wall thickness of the film.

The invention further provides a composite part, which is manufactured by a method according to the invention. This composite part in particular is part of an interior door trim of a motor vehicle.

Such a composite part may for example be part of an instrument panel, part of a door trim or part of a middle console.

The invention is now represented by way of an embodiment example which is additionally sketched by several figures. There are shown in

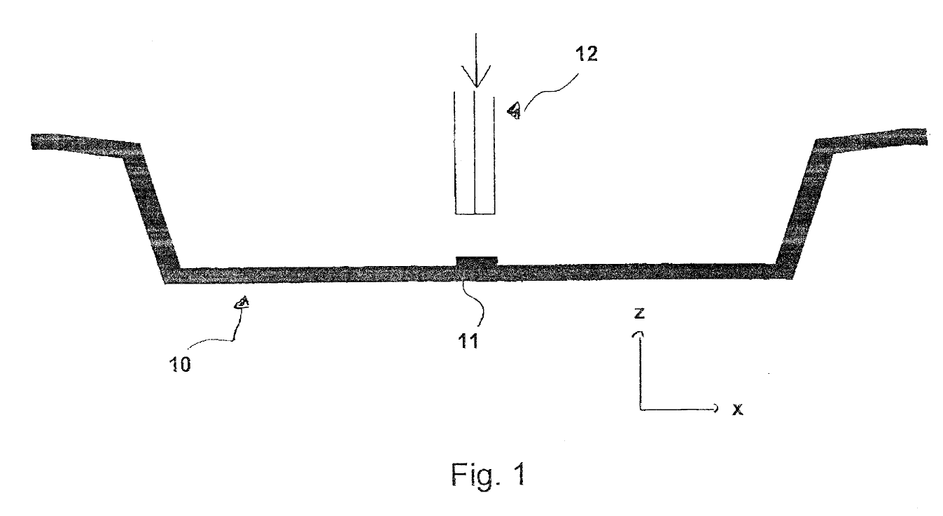

FIG. 1 a tool for manufacturing a multicoloured plastic film according to step (a) of the method according to the invention,

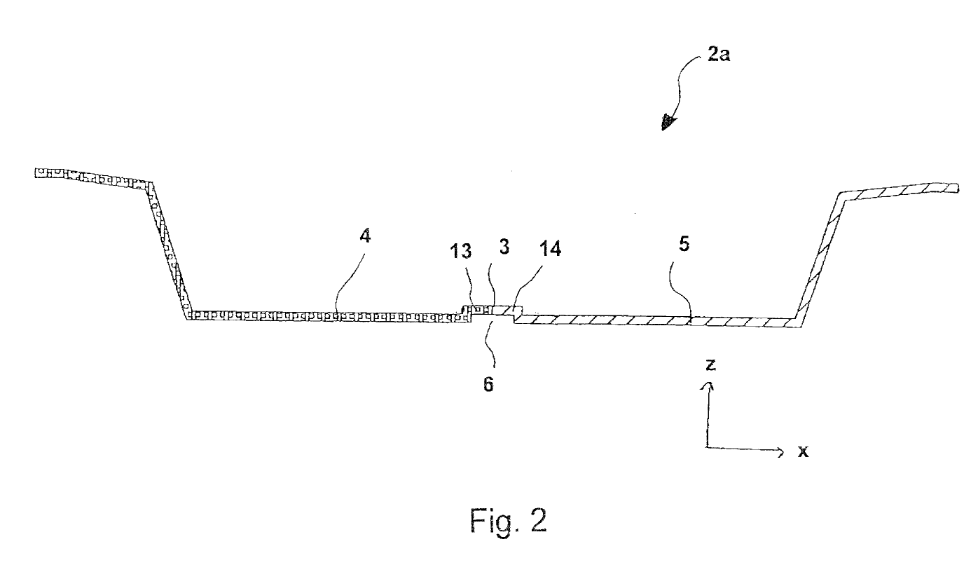

FIG. 2 a multicoloured plastic film according to step (a) of the method according to the invention,

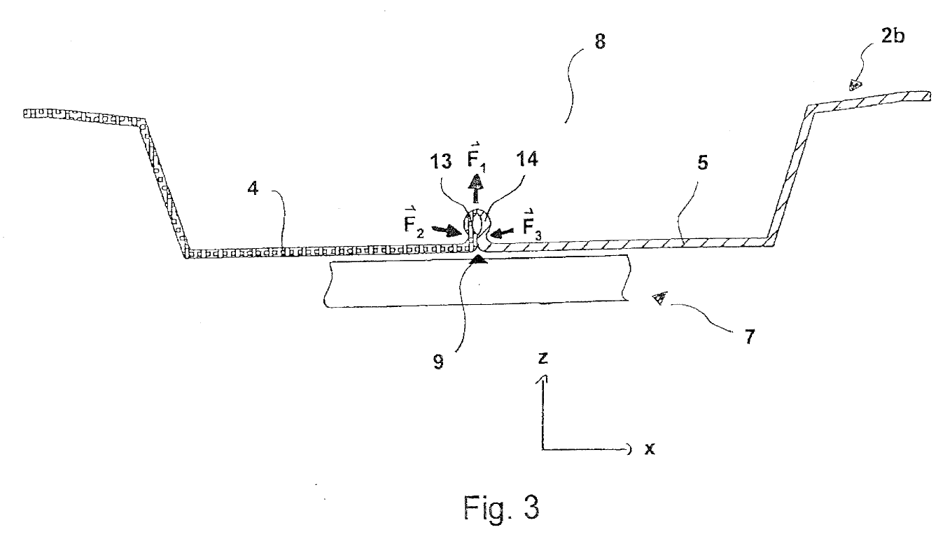

FIG. 3 a multicoloured plastic film according to step (c) of the method according to the invention,

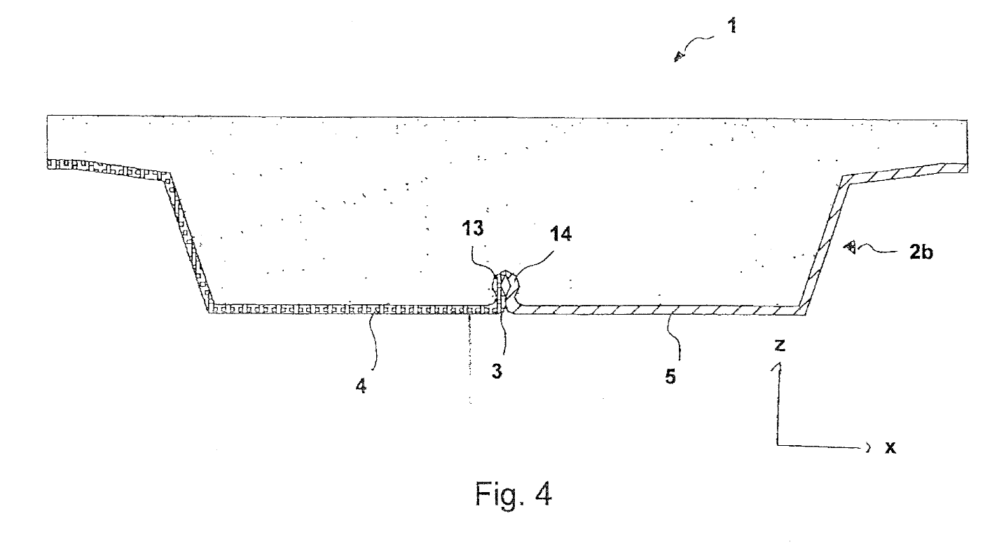

FIG. 4 a component manufactured according to the method according to the invention.

FIG. 1 shows a tool for manufacturing a multicoloured plastic film according to step (a) of the method according to the invention, by way of a slush-moulding method.

What is shown is a galvano-mould 10. The inner surface of this galvano-mould 10 determines the shape of the film manufactured in this method. The galvano-mould 10 comprise a web 11 on its inner surface 11.

Furthermore, the tool comprises a seal 12 which is arranged within the galvano-mould 10, and with which individual regions of the galvano-mould 10 defined by the web may be sealed.

The regions separated by the seal are powdered with plastics of different colours by way of powder boxes, for manufacturing the multicoloured plastic film. The powder is liquefied by way of heating the galvano-mould 10, and this forms a plastic film on the inner side of the galvano-mould 10. Thereby, the seal 12 prevents the individual plastic films from running over into one another. The plastic film manufactured in this manner may be removed from the tool after cooling the galvano-mould 10.

FIG. 2 shows a multicoloured plastic film after step (a) of the method according to the invention.

Such a plastic film may for example be manufactured with the just described slush-moulding method, but basically the method according to the invention is independent of the manufacture of the multicoloured plastic film.

The plastic film 2a has a first colour region 4 and a second colour region 5. These two colour regions 4 and 5 border one another. The plastic film 2a comprises a groove 6 in this border region 13 and 14 of the colour regions 4 and 5 respectively. The groove 6 is arranged on the viewed side of the plastic film 2a. It has a width of 5 mm (x-direction) and a depth of 3 mm (z-direction). Its dimensions are defined by the web 11 of the galvano-mould 10 (see FIG. 1).

The plastic film 2a has a uniform wall thickness of 2 mm. Accordingly, the groove 6 of the plastic film 2a on the viewed side is formed on the rear side as a web.

FIG. 3 shows a multicoloured plastic film after step (c) of the method according to the invention.

After the manufacture of the multicoloured plastic film 2a which is shown in FIG. 2, the plastic film 2a is positioned in a cavity 8 of a foaming tool 7 according to the method according to the invention. The foaming tool 7 comprises a web 9 on the surface of its cavity 8, in order to simplify the positioning. The plastic film 2a is now positioned such that the web 9 engages into the opening of the groove 3.

The web 9 is designed as an isosceles triangle. The angles of the triangle are 45° and in each case 67.5°. The triangular web is orientated such that the acute angle of 45° projects perpendicularly into the cavity 8 of the foaming tool 7. The height of the web is 1.5 mm (z-direction).

A vacuum is applied between the surface of the cavity 8 of the foaming tool 7 and the film 2a for holding the film 2a. The foaming tool comprises corresponding openings, in order to permit the application of the vacuum.

Furthermore, the foaming tool 7 is preheated to a temperature of 70°. The film 2a is likewise at a temperature of about 70° C.

The film regions 13 and 14 lying along the groove 6 are partly pulled by hand into the inside of the cavity 8 of the foaming tool 7 whilst applying a force F₁ which is orientated roughly in the z-direction. For this, one engages on the web of the plastic film 2a which lies on the rear side of the groove 6. Simultaneously, the film regions 13 and 14 pulled into the inside of the cavity, are led together by applying a force F₃ directed from the right and a force F₂ directed from the left, which are roughly orientated in the x-direction, for closing the recess between the film and the surface of the foaming tool 7, said recess being produced by the partial pulling-in F₁ of the film 2a.

The film 2a is pulled into the inside of the cavity 8 along the web 9. The respective film region is pressed against the respective limb of the triangular web 9 on leading the film regions 13 and 14 together. The two film regions 13 and 14 are pressed onto one another above the web 9 or at the tip of the web 9.

The pulling-in and leading-together of the film regions 13 and 14 is possible on account of the low wall thickness of the film, and the temperature of the film. The film is fixed in its position by way of the applied vacuum.

FIG. 4 shows a composite part 1 which is manufactured according to the method according to the invention.

The prepared plastic film 2b is back-foamed after the preparation of the plastic film 2a described above. The pulled-in film regions 12 and 14 are located within the foam layer of the composite part 1. The border region between the colour regions 4 and 5 thus lies within the foam layer, and is not visible from the outside. A defined separation line between the individual colour regions 4 and 5 is achieved on the surface of the composite part 1. The separation line runs along a gap which is defined by the geometry of the triangular web 9. This gap however is very inconspicuous on account of the fact that the dimensions of the gap are very small.

An injection moulding tool may be used as an alternative instead of the foaming tool 7. The prepared plastic film 2b is accordingly back-injected or back-injection-stamped.

The manufactured composite part is in particular suitable as part of an instrument panel, a door trim or a middle console.

1-10. (canceled)

11. A method for manufacturing a composite part with a multicolored surface, comprising the steps:
a) manufacturing a multicolored plastic film, the film including a groove in a region of color regions bordering one another;
b) positioning the film in a cavity of a tool;
c) partial pulling of the regions lying along the groove, into the inside of the cavity with one of a simultaneous and a subsequent leading-together of the regions pulled into the inside of the cavity, for the closure of a recess between the film and the surface of the tool, the recess being produced by the partial pulling-in of the film; and
d) one of back-foaming and back-injecting the film,
wherein the tool includes a web on the surface of the cavity, the film being positioned such that the web engages into an opening of the groove, the web having a triangular shape with a tip projecting out of the surface of the cavity.

12. A method according to claim 11, wherein a vacuum is applied between the surface of the cavity and the film in order to hold the film.

13. A method according to claim 11, wherein the film is pulled into the inside of the cavity along the web.

14. A method according to claim 11, wherein the groove has a width in a region between 2.5 mm and 25 mm and a depth in a region between 2.5 mm and 15 mm

15. A method according to claim 11, wherein the groove has at least one of a width in a region between 3 mm and 7 mm and a depth in a region between 3 mm and 7 mm,

16. A method according to claim 13, wherein the web has a width in a region between 1 mm and 5 mm and a height in a region between 1 mm and 7 mm.

17. A method according to claim 13, wherein the web has at least one of a width in a region between 1 mm and 2 mm and a height in a region between 1 mm and 3 mm.

18. A method according to claim 11, wherein the film has a thickness in a region between 0.5 mm and 5 mm.

19. A method according to claim 11, wherein the film has a thickness in a region between 1 mm and 2.5 mm.

20. A method according to claim 11, wherein the film is manufactured in one of a molding method and a slush method.

21. A composite part, manufactured by a method comprising the steps of:
a) manufacturing a multicolored plastic film, the film including a groove in a region of color regions bordering one another;
b) positioning the film in a cavity of a tool;
c) partial pulling of the regions lying along the groove, into the inside of the cavity with one of a simultaneous and a subsequent leading-together of the regions pulled into the inside of the cavity, for the closure of a recess between the film and the surface of the tool, the recess being produced by the partial pulling-in of the film; and
d) one of back-foaming and back-injecting the film,
wherein the tool includes a web on the surface of the cavity, the film being positioned such that the web engages into an opening of the groove, the web having a triangular shape with a tip projecting out of the surface of the cavity.

22. A composite part according to claim 21, wherein the part is an interior trim part of an automobile.
